(19) United States
(12) Patent Application Publication
(10) Pub. No.: US 2002/0069198 A1
(43) Pub. Date: Jun. 6, 2002

(54) System and method for positive identification of electronic files

(75) Inventors: David Stebbings, Vienna, VA (US); Adam William Strasel, Centreville, VA (US)

Correspondence Address: GREENBERG-TRAURIG, 1750 TYSONS BOULEVARD, 12TH FLOOR, MCLEAN, VA, 22102, US

(73) Assignee: InfoSeer, Inc., McLean, VA

(21) Appl. No.: 09/942,944

(22) Filed: Aug. 31, 2001

Related U.S. Application Data
(60) Provisional application No. 60/229,037, filed on Aug. 31, 2000.
(60) Provisional application No. 60/229,040, filed on Aug. 31, 2000.
(60) Provisional application No. 60/229,038, filed on Aug. 31, 2000.
(60) Provisional application No. 60/229,039, filed on Aug. 31, 2000.
(60) Provisional application No. 60/248,283, filed on Nov. 14, 2000.

(51) Int. Cl. G06F 7/00

(52) U.S. Cl. 707/7

(57) ABSTRACT

A method of identifying electronic files comprising the steps of identifying a beginning of the content within a file being transmitted through a network, generating a tag based on content of the file, and comparing the tag to other tags in a database of tags to measure similarity between the tag and the other tags.

This application claims priority to U.S. Provisional Patent Application No. 60/229,037, filed Aug. 31, 2000, U.S. Provisional Patent Application No. 60/229,040, filed Aug. 31, 2000, U.S. Provisional Patent Application No. 60/229,038, filed Aug. 31, 2000, U.S. Provisional Patent Application No. 60/229,039, filed Aug. 31, 2000, U.S. Provisional Patent Application No. 60/248,283, filed Nov. 14, 2000, U.S. Provisional Patent Application No. ______, entitled SYSTEM AND METHODS FOR INCORPORATING CONTENT INTELLIGENCE INTO NETWORK SWITCHING, FIREWALL, ROUTING AND OTHER INFRASTRUCTURE EQUIPMENT, filed Aug. 23, 2001, and U.S. Provisional Patent Application No.______, entitled SYSTEM AND METHODS FOR POSITIVE IDENTIFICATION AND CORRECTION OF FILES AND FILE COMPONENTS, filed Aug. 23, 2001, which are all incorporated herein by reference.

This application is related to commonly owned U.S. patent application Ser. No.______, filed on Aug. 31, 2001, entitled SYSTEM AND METHOD FOR TRACKING AND PREVENTING ILLEGAL DISTRIBUTION OF PROPRIETARY MATERIAL OVER COMPUTER NETWORKS, commonly owned U.S. patent application Ser. No.______, filed on Aug. 31, 2001, entitled SYSTEM AND METHOD FOR PROTECTING PROPRIETARY MATERIAL ON COMPUTER NETWORKS and commonly owned U.S. patent application Ser. No. ______, filed on Aug. 31, 2001, entitled SYSTEM AND METHOD FOR CONTROLLING FILE DISTRIBUTION AND TRANSFER ON A COMPUTER, which are all incorporated by reference as if fully recited herein.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND OF THE INVENTION

1. Field of the Invention

The present invention relates to the field of computer software, and more particularly, to a system and method for positively identifying electronic files so as to recognize, track and/or verify transfer of electronic files.

2. Discussion of the Related Art

The ability to positively identify electronic files is essential to managing the use and distribution of those files. File names are insufficient for the purpose of file identification. Stenographic techniques, such as watermarking, alter the actual data content and these are unacceptable in many applications. In addition, legacy files exist for which there is no steganographic solution, because the original is fixed or unobtainable. Examples are music CD's, software ROM's and movies already sold and existing in consumers homes.

### SUMMARY OF THE INVENTION

Accordingly, the present invention is directed to a system and method for positive identification of electronic files that substantially obviates one or more of the problems due to limitations and disadvantages of the related art.

An object of the present invention is to provide a method of identifying proprietary content on a computer network.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in one aspect of the present invention there is provided a method of identifying electronic files comprising the steps of identifying the beginning of content data within a file being transmitted through a network, generating a tag based on content of the file, and comparing the tag to other tags in a database of tags to measure similarity between the tag and the other tags.

In another aspect of the present invention there is provided a system for identifying electronic files comprising means for identifying a start point of the actual content data after the “Headers” and other administration data within a file being transmitted through a network, means for generating a tag based on content of the file; and means for comparing the tag to other tags in a database of tags to measure similarity between the tag and the other tags.

In another aspect of the present invention there is provided a computer program product for identifying electronic files comprising a computer usable medium having computer readable program code means embodied in the computer usable medium for causing an application program to execute on a computer system, the computer readable program code means comprising computer readable program code means for identifying a start point of data within a file being transmitted through a network, computer readable program code means for generating a tag based on content of the file; and computer readable program code means for comparing the tag to other tags in a database of tags to measure the similarity and differences between the tag and the other tags.

In another aspect of the present invention there is provided a method of identifying electronic files comprising the steps of identifying a file being transmitted through a network, generating a tag based on file, and comparing the tag to other tags in a database of tags to measure similarity between the tag and the other tags.

It is to be understood that both the foregoing general description and the following detailed description are exemplary and explanatory and are intended to provide further explanation of the invention as claimed.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram showing an overview of the system of the present invention; and

FIG. 2 is a schematic block diagram illustrating the system in the context of protecting and promoting copyrighted music.

### DETAILED DESCRIPTION OF THE PREFERRED EMBODIMENT

Reference will now be made in detail to the preferred embodiments of the present invention, examples of which are illustrated in the accompanying drawings.

For the sake of consistent terminology, the following convention will be used:

A unique identifier (hereinafter, tag, InfoTag, or InfoScan identifier) is created for each file, using sophisticated digital signal processing techniques. The InfoTag, apart from accurately identifying the file, is used to control content to ensure that it moves across the network infrastructure consistent with the owner's requirements. The InfoTag is not embedded in the files or the header, thereby making it literally undetectable. In the case of music, the lnfoTag may be created based on, for example, the first 30 seconds of the song. The InfoTag may also contain such information as IP address of the source of the file, spectral information about the file, owner of the file, owner-defined rules associated with the file, title of work, etc.

InfoMart is an information storage system, normally in the form of a database. It maintains all the identifiers (tags) and rules associated with the protected files. This data can be used for other value-added marketing and strategic planning purposes. Using the DNS model, the InfoMart database can be propagated to ISP's on a routine basis, updating their local versions of the InfoMart database.

InfoWatch collects information about content files available on the Internet using a sophisticated information flow monitoring system. InfoWatch searches to find protected content distributed throughout the Internet. After the information is collected, the content is filtered to provide the content owners with an accurate profile of filesharing activities.

InfoGuard is the data sentinel. It works within the network infrastructure (typically implemented within a router or a switch, although other implementations are possible, such as server-based, as well as all-hardware, or all-software, or all-firmware, or a mix thereof) to secure intellectual property. InfoGuard can send e-mail alerts to copyright violators, embed verbal and visual advertisements into the inappropriately distributed content, inject noise into the pirated content, or stop the flow of the content all together. InfoGuard may be thought of a type of intelligent firewall, an intelligent router, or an intelligent switch, in that it blocks some content files from being transferred, while permitting others to pass, or to pass with alterations/edits. InfoGuard can identify the type of file and identity of the file by creating a tag for it, and comparing the tag to a database of tags (InfoMart database).

Additionally, the following two appendices are incorporated by reference as if fully recited herein: APPENDIX 1, entitled White Paper: InfoSeer Audio Scan Techniques, and APPENDIX 2, entitled InfoSeer Inc. Response to RIAA/IFPI Request for Information on Audio Fingerprinting Technologies, July 2001.

The system incorporates algorithmic approaches to the generation of a digital tag, akin to the concept of a fingerprint or signature. The tag-generation algorithm typically includes at least three components: 1) origin identification; 2) tag generation and 3) tag verification. The tags are stored in a database where they can be compared to other tags (comparison tags). The comparison tags are generated by the same algorithms, either in real time, or less than real time. After comparison, action is taken based upon the file owner's request. For example, the file may be diverted and/or logged with IP addresses and time stamps or the file transfer can be stopped. Also, substitute messages may be transferred, in addition to, or instead of, the original. The software system is used within computer networks to track and validate those files.

An important question of unique tag, or identification, which is not incorporated into the file but can be used by external systems to positively identify the file (for example, by an intelligent router, an intelligent switch, a server, or a local machine).

There are two basic purposes for the identification tag. The first is to establish a unique ID for each individual file. This is a universal requirement irrespective of the type of file being tagged. The second is to ensure that the file has not been interfered with or altered in any way. This second purpose is particularly important to ensure the integrity of sensitive corporate information, such as trade secrets, financial or medical records, or military information. Some files may not need this level of measured integrity, whereas, for others, it may be essential. The system and method described herein enables both or only one of these alternatives.

The software system and method, incorporates algorithmic approaches to the generation of a digital tag (which may be thought of as a fingerprint or signature) of the electronic data file. Algorithms can vary and are generally optimized for the type of file to be tagged. For example an algorithm for tagging music will be optimized for this purpose. The algorithm for tagging music will be used for all music, while an algorithm for tagging documents will be used for all documents.

Another requirement of the tag is that it needs to be a relatively small file (compared to the original file), so that it can be placed in a database that can be rapidly searched. Such a database may have several million items in it. Therefore, it is important that the tag be both unique and short. For example, it may be a few to a few tens or hundreds of bytes in size. The files represented by the tag, however may be several tens of thousands of bytes or several megabytes or even, as in the case of MPEG2 encoded movies be several gigabytes in size. There are other properties and purposes for the tags that will become clear as the invention is described to anyone familiar in the art. For example, the tags should be robust, meaning an acceptable tradeoff between false positive identification, and false negative identification. Another property relates to distortion in the original file, and the tag's ability to match it despite a reasonably high degree of distortion.

The tags may be incorporated in a system that will track and validate the use of files on computer networks and personal computers.

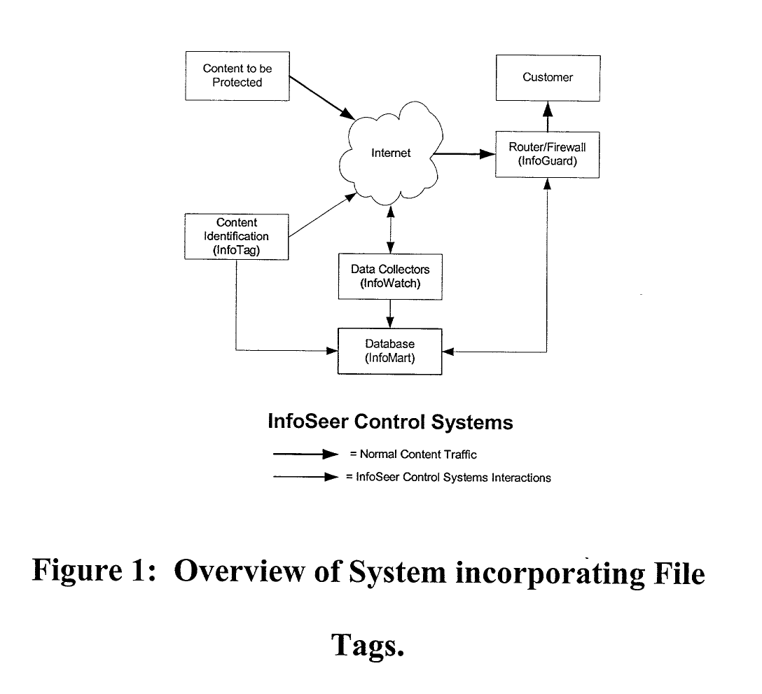

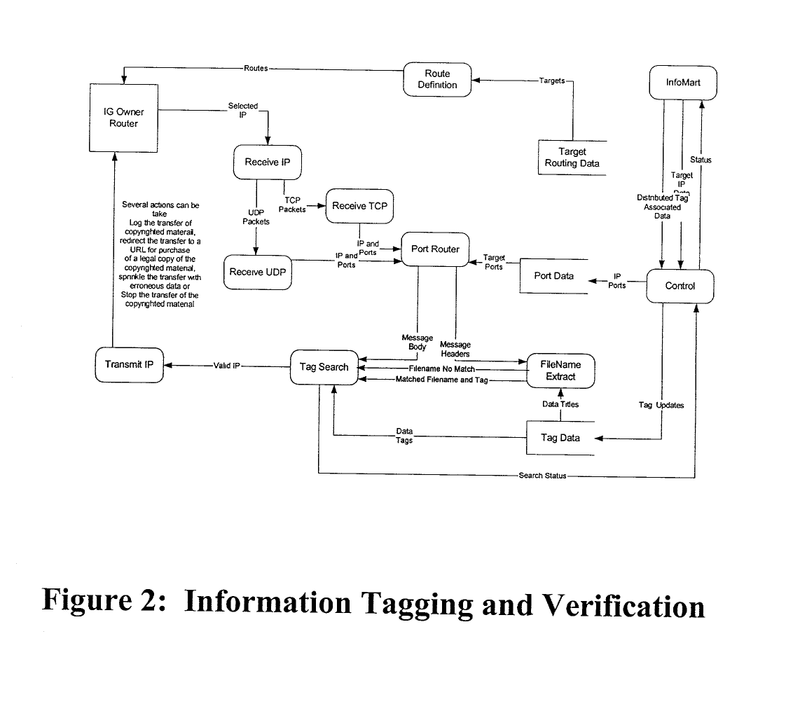

The present invention, as will be described in more detail below with reference to FIGS. 1 and 2, provides a system and method for positively identifying electronic files to recognize, track and/or verify electronic files. In a preferred embodiment, the tag includes several segments.

The first step of the tag-generation algorithm is origin (beginning of content) identification. The origin identification algorithm is used to enable tag generation and tag verification segments of the origin identification algorithm to correctly identify the start point within the electronic data. This is required to allow the tag generation and tag verification to respond to alterations in the data that are caused by data transmission errors, or which are inserted for the purpose of avoiding tag verification. Note that it is not always necessary to identify the origin of the content, since the tag generation algorithm can also apply to the entire file, and not just the content.

The second step of the tag-generation algorithm is application of a series of mathematical formulae to the incoming data to create a tag comprised of at least three components. The first component is a hash sum, that is, a unique sum related directly and exclusively to the data within the file. The second component is a shape fit formula that identifies a set of points that are unique to the file content. The third component of the tag is a statistical evaluation of the relative value of the data bytes within the file. The details of these components vary according to file type.

The third step of the tag-generation algorithm is tag verification. Tag verification is a mechanism that allows for a tailored application of the tag generation capability to allow real-time confirmation of file content. This enables the measurement of file integrity discussed above.

The tag may also incorporate other administration features. It may incorporate a time and date of tagging stamp. This may be useful when a file owner has time-dependent action rules associated with the file. For example a file may kept secure until a certain date, or for a certain amount of time after tagging, and then it would be available freely.

It may incorporate an identifier indicating file type. This feature may be helpful for making fast sorts in a database.

The tag may incorporate a parity or error-correcting algorithm to indicate if the tag has been corrupted accidentally or intentionally. It may have a reference as to tag generation. It may have an error detection and correction scheme, e.g., Reed Solomon. This will be useful, as it is expected that tags will be developed with more sophistication (and many additional fields/components) in the future, according to changing requirements.

The tag may incorporate encryption, since the entire system must be secure against compromise.

The tag may incorporate a reference number indicating the encryption level as an aid to security of the tag, if the encryption has to be reworked. It may incorporate an encryption system that would facilitate change of the encryption details by enabling a software algorithm to be run to change the tags in the entire InfoMart database (possibly an encrypted database). This is important, since otherwise all the tags in the database may have to be re-established from the original files, a potentially lengthy and expensive process.

It may also incorporate other database security techniques which will be familiar to any one knowledgeable in the art. For example, it may incorporate a method of tagging viruses, present either as a file directly, or as an attachment to an email or other message. The purpose would be to find and eliminate such viruses from networks and ongoing content/file distribution channels.

In the preferred embodiment, the file creator or owner can initially tag the file using the software system into which these algorithms are incorporated. FIG. 1 illustrates the role of the tag, identified as “Content Identification” (InfoTag).

In the preferred embodiment, the tags are stored in the InfoMart database after the tag is generated, and the database can be divided according to the types of file the tags apply to. By way of example, there may be a movie portion, a music portion, a document portion, and many more.

The file/document being analyzed may be interleaved. This is useful for error detection and correction purposes. It can also be useful when creating a tag for a document that might have a paragraph removed from it. With interleaving, the absence of a paragraph would still result in a tag that can be compared to the tag for the original document.

When data is traversing networks such as LAN's (Local Area Networks), WAN's (Wide Area Networks) or the Internet, these same algorithms are run over the file as it is being transferred, either in real, or faster than real, time. When the tag has been derived or generated, a search is performed in the database to see if the file is known. If a match is obtained, then the instructions are inspected which have been loaded by the owner of the file, and associated with the tags in the database. Action is then taken according to the owner's instructions. For example, the file may be diverted, or logged with IP addresses and time stamps, or the transfer stopped. Also, substitute messages or web site links may be transferred in addition to, or instead of the original. By this means the software system is used within computer networks to track and validate the use of files. The software algorithms can be run virtually on all computers or other equipment, or produced in dedicated firmware according to the requirements of any given application.

In the preferred embodiment, the following aspects are present:

1. The definition and use of an original file recognition mechanism to successfully indicate whether or not the file has been subject to data alteration, whether intentional or unintentional.

2. An algorithm combining the use of special directed algorithms such as a hash sum, shape fit and statistical analysis for the purpose of the identification of electronic files. Other sophisticated algorithms can be used according to file type (e.g., Fast Fourier Transforms, DFT's, DCT's, and others).

3. The incorporation of the tags into a database designed to facilitate high-speed searches. The database is preferably segmented according to file tag type and other fast search considerations.

4. The integration of the tagging algorithm into standard IP routing systems and protocols to create a real-time, high-speed electronic file transfer detection mechanism.

5. The integration of the above aspects into a single software and/or firmware or hardware system.

6. To incorporate additional tag content and properties into the tag to enable security, administration and marketing requirements associated with the tagged files.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method of identifying electronic files comprising the steps of:
identifying a beginning of content within a file;
generating a tag based on content of the file; and
comparing the tag to other tags in a database of tags to measure similarity between the tag and the other tags.

2. The method of claim 1, wherein the step of generating the tag uses a Fast Fourier Transform.

3. The method of claim 1, wherein the step of generating the tag uses a Discrete Cosine Transform.

4. The method of claim 1, wherein the step of generating the tag uses a shape fit algorithm.

5. The method of claim 1, wherein the step of generating the tag uses a statistical evaluation of relative value of data bytes within the file.

6. The method of claim 1, wherein the step of generating the tag uses a hash sum.

7. The method of claim 1, wherein the step of generating the tag adds time and date stamp to the tag.

8. The method of claim 1, wherein the step of generating the tag adds a file type identifier to the tag.

9. The method of claim 1, wherein the step of generating the tag incorporates an error detection and correction scheme into the tag.

10. The method of claim 1, wherein the step of generating the tag incorporates encryption into the tag.

11. The method of claim 1, wherein the step of generating the tag generates a level shift insensitive tag.

12. The method of claim 1, wherein the step of generating the tag generates a time shift insensitive tag.

13. The method of claim 1, wherein the step of generating the tag generates a time compression insensitive tag.

14. The method of claim 1, wherein the step of identifying the beginning of the content ignores “quiet time” in a beginning of a music file.

15. The method of claim 1 wherein the step of comparing the tag uses a percent match.

16. The method of claim 1, wherein the step of comparing the tag uses a frequency weight analysis.

17. The method of claim 1, wherein the step of comparing the tag uses a magnitude weight analysis.

18. The method of claim 1, wherein the step of comparing the tag uses a fast track ellipse analysis.

19. The method of claim 1, wherein the step of comparing the tag uses a magnitude weight analysis.

20. A system for identifying electronic files comprising:
means for identifying a beginning of the content within a file;
means for generating a tag based on content of the file; and
means for comparing the tag to other tags in a database of tags to measure similarity between the tag and the other tags.

21. The system of claim 20, wherein the means for generating the tag uses a Fast Fourier Transform.

22. The system of claim 20, wherein the means for generating the tag uses a Discrete Cosine Transform.

23. The system of claim 20, wherein the means for generating the tag uses a shape fit algorithm.

24. The system of claim 20, wherein the means for generating the tag uses a statistical evaluation of relative value of data bytes within the file.

25. The system of claim 20, wherein the means for generating the tag uses a hash sum.

26. The system of claim 20, wherein the means for generating the tag adds time and date stamp to the tag.

27. The system of claim 20, wherein the means for generating the tag adds a file type identifier to the tag.

28. The system of claim 20, wherein the means for generating the tag incorporates an error detection and correction scheme into the tag.

29. The system of claim 20, wherein the means for generating the tag incorporates encryption into the tag.

30. The system of claim 20, wherein the means for generating the tag generates a level shift insensitive tag.

31. The system of claim 20, wherein the means for generating the tag generates a time shift insensitive tag.

32. The system of claim 20, wherein the means for generating the tag generates a time compression insensitive tag.

33. The system of claim 20, wherein the means for identifying the beginning of the content ignores “quiet time” in a beginning of a music file.

34. The system of claim 20, wherein the means for comparing the tag uses a percent match.

35. The system of claim 20, wherein the means for comparing the tag uses a frequency weight analysis.

36. The system of claim 20, wherein the means for comparing the tag uses a magnitude weight analysis.

37. The system of claim 20, wherein the means for comparing the tag uses a fast track ellipse analysis.

38. The system of claim 20, wherein the means for comparing the tag uses a magnitude weight analysis.

39. The system of claim 20, wherein the means for comparing the tag also compares differences between the tag and the other tags.

40. A computer program product for identifying electronic files comprising:
a computer usable medium having computer readable program code means embodied in the computer usable medium for causing an application program to execute on a computer system, the computer readable program code means comprising:
computer readable program code means for identifying a beginning of the content within a file being transmitted through a network;
computer readable program code means for generating a tag based on content of the file; and
computer readable program code means for comparing the tag to other tags in a database of tags to measure similarity between the tag and the other tags.

41. A method of identifying electronic files comprising the steps of:
identifying a file being transmitted through a network;
generating a tag based on file; and
comparing the tag to other tags in a database of tags to measure similarity between the tag and the other tags.

42. A system for identifying electronic files comprising:
means for identifying a file being transmitted through a network;
means for generating a tag based on the file; and
means for comparing the tag to other tags in a database of tags to measure similarity between the tag and the other tags.
